(19) United States
(12) Patent Application Publication
(10) Pub. No.: US 2023/0131488 A1
(43) Pub. Date: Apr. 27, 2023

(54) SMART OPTICAL JUNCTION BOX

(71) Applicant: NEXANS, Courbevoie (FR)

(72) Inventors: Cyril LIMA, SEDAN (FR); Julien DEVAUX, CHALANDRY-ELAIRE (FR)

(21) Appl. No.: 17/949,894

(22) Filed: Sep. 21, 2022

(30) Foreign Application Priority Data
Sep. 27, 2021 (FR) 2110143

(51) Int. Cl. G02B 6/44; G01K 11/00; H02G 3/08

(52) U.S. Cl. CPC G02B 6/4441; G01K 11/00; H02G 3/08

(57) ABSTRACT

An optical fibre junction box (10) has at least one status sensor (12) measuring at least one physical parameter of the box (10) and/or detecting the opening and closing of the box (10) and an electronic means (14) for remotely identifying the box (10).

### RELATED APPLICATION

This application claims the benefit of priority from French Patent Application No. 21 10143, filed on Sep. 27, 2021, the entirety of which is incorporated by reference.

The present invention relates to a smart optical junction box.

The invention is in the field of fibre optic telecommunications networks.

### BACKGROUND

Fibre optic telecommunications networks particularly comprise fibre optic cables and optical junction boxes.

The junction boxes can be installed outside or in buildings. They protect the optical fibres, splices and connections.

When they are installed outside, in particular in a distribution enclosure or on a post, junction boxes are subject to unpredictable weather conditions. Water ingress can partially or completely degrade the performance capabilities of the optical network.

Inside buildings, any infiltration of dust or insects can also degrade the performance capabilities of the optical network. Furthermore, such degradations are unpredictable and are not currently anticipated.

Moreover, the junction boxes are installed by service technicians. When the networks are shared, different technicians respectively work on behalf of different operators. It is therefore difficult to precisely identify the technician for installation or when subsequent work is carried out on the box. When it is possible, this identification is not immediate. However, most failures occur when a technician has to open the boxes, thus causing external elements to enter and unintentional disconnections of the pre-determined connections.

Furthermore, on dense networks, several boxes can be installed in close proximity to each other. This makes them difficult to identify, which creates a risk of not working on the correct box.

Indeed, theoretically, each box has a unique physical identification, for example, by means of a punchable or printed tag, a QR code or an ink marking. However, the life time of this means of identification varies depending on its nature (indelible ink, metal, plastic, adhesive tag, etc.). When the identification is no longer legible or is missing, the technician cannot be sure that they are working on the correct box and can be mistaken or lose a significant amount of time searching in order to complete the correct connections at the correct locations.

Finally, each intervention on a box potentially creates stress on the optical fibres. In addition, some of the functionalities or capabilities of the box can be altered during the intervention. Given the lack of a log of any interventions on these boxes, it is impossible to know the precise state of each box in order to be able to anticipate any failures. On some sites, a logbook is theoretically completed by the technician for each intervention, but in practice it is almost non-existent, not always completed and cannot be consulted remotely. No preventive maintenance can be shared between network operators, and status tests, such as leakage tests for sealed boxes provided with a valve, must be carried out in situ.

### OBJECTS AND SUMMARY

The aim of the present invention is to overcome the aforementioned shortcomings of the prior art.

To this end, the present invention proposes an optical fibre junction box, characterized in that it comprises:

at least one status sensor measuring at least one physical parameter of the box and/or detecting the opening and closing of the box; and
means for remotely identifying the box using electronic means.

Thus, the present invention allows the junction box to be safely and permanently identified and the status of the box to be known dynamically without having to travel. This allows any failures to be anticipated and any errors in identifying the box during the intervention of the technician to be avoided.

In a particular embodiment, the junction box further comprises a smart locking device.

This ensures that only the authorized technician can open and close the box in the event of an intervention.

In a particular embodiment, the remote identification means is an NFC or RFID tag.

Such a tag is very easy to install on the box and allows reliable and contactless communication.

In a particular embodiment, the status sensor measures the moisture content of the box.

This allows any water ingress to be detected that is detrimental to the operation of the optical network.

In a particular embodiment, the status sensor measures the temperature of the box.

This allows any failures to be anticipated that are due to temperatures outside the normal operating ranges of the box.

For the same purpose as indicated above, the present invention also proposes a system for monitoring the integrity of a fibre optic telecommunications network, characterized in that it comprises:

at least one junction box as briefly described above;
a platform for monitoring interventions in the network adapted to communicate with the at least one junction box.

In addition to the same advantages and specific features as those of the aforementioned box, the proposed monitoring system allows the technicians working on the one or more box(es) of the network and the one or more relevant box(es), as well as the nature of these interventions, to be identified. It is thus possible to organize predictive maintenance of the network.

In a particular embodiment of the system, the platform comprises means for recording the interventions.

This allows a log of the interventions to be available that facilitates monitoring of the operation of the one or more box(es) of the network, as well as the predictive maintenance of this network.

### BRIEF DESCRIPTION OF THE DRAWINGS

Further aspects and advantages of the invention will become apparent from reading the following detailed description of particular embodiments, which are provided solely by way of non-limiting examples, with reference to the accompanying drawing, in which:

FIG. 1 is a schematic representation of a box according to the present invention, in a particular embodiment.

### DETAILED DESCRIPTION

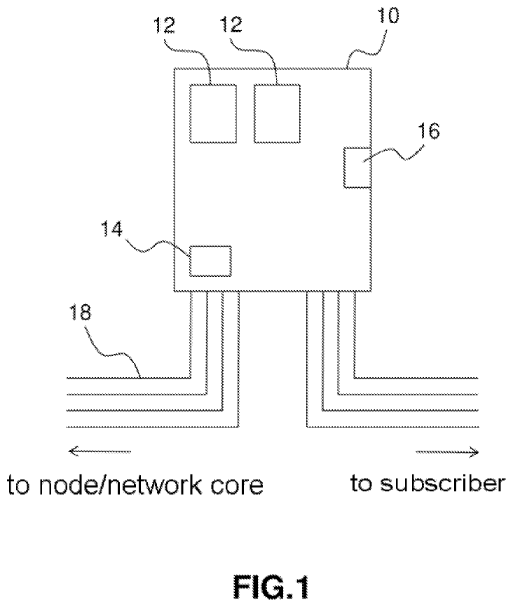

As shown in FIG. 1, in a particular embodiment, an optical junction box 10 according to the present invention comprises one or more status sensor(s) 12, which measure at least one physical parameter of the box 10 and/or which detect the opening and closing of the box 10.

By way of a non-limiting example, this physical parameter can be the moisture content of the box 10 or the temperature of the box 10 or the pressure, shocks, vibrations, etc.

The box 10 further comprises means 14 for remotely identifying the box using electronic means.

By way of a non-limiting example, the remote identification means 14 can be an NFC (Near Field Communication) or RFID (Radio Frequency IDentification) tag. This tag is, for example, printed directly on the box 10, or is on a self-adhesive tag affixed, for example, on the outside of the box 10. As an alternative embodiment, the remote identification means 14 can be produced in the form of a badge and can be located inside the box 10.

Optionally, the box 10 can further comprise a smart locking device 16, equipped with electronic circuitry allowing it to be remotely controlled via an optionally mobile telecommunications terminal. Opening and closing the box 10 can be dependent on the execution of a user authentication procedure. The open or closed status of the box 10 can be stored in a remote register. The smart locking device 16 can communicate with the outside, for example, via NFC or RFID technology, such as the means 14 for remotely identifying the box 10.

FIG. 1 shows that the box 10 is connected, in a manner known per se, to a fibre optic telecommunications network 18, on the one hand, to a node belonging to the core of the network 18 and, on the other hand, to a subscribed item of equipment, i.e., to an item of equipment of a user of the network 18.

A system for monitoring the integrity of the network 18 according to the present invention comprises at least one junction box 10 as described above, as well as a platform for monitoring interventions in the network 18.

The monitoring platform is adapted to communicate with the box. For example, if the box 10 comprises means 14 for remotely identifying the box in the form of an NFC tag, the monitoring platform comprises reading means adapted to transmit and receive signals to and from the NFC tag of the box 10 and from the one or more status sensor(s) 12.

In addition, the monitoring platform can comprise an enrolment register for technicians carrying out the interventions, containing identification information of these technicians.

Optionally, the monitoring platform can also comprise means for recording interventions, which store, for example, the date, time and the duration of the interventions, the identification data of the technician who carried out the intervention and the identification information of the relevant box 10, as well as the value of the physical parameters measured by the one or more sensor(s) 12 at the beginning and the end of the intervention.

The invention is applicable to all types of optical networks, whether they are FTTH (Fibre To The Home), FTTE (Fibre To The Enterprise) or mobile networks.

It can be easily extended to elements of a network other than the junction boxes.

1. An optical fibre junction box, wherein said optical fibre junction box comprises:
at least one status sensor measuring at least one physical parameter of said box and/or detecting the opening and closing of said box; and
means for remotely identifying said box using electronic means.

2. The optical fibre box according to claim 1, wherein said optical fibre box further comprises a smart locking device.

3. The optical fibre box according to claim 1, wherein said remote identification means is an NFC or RFID tag.

4. The optical fibre box according to claim 1, wherein said status sensor measures the moisture content of said box.

5. The optical fibre box according to claim 1, wherein said status sensor measures the temperature of said box.

6. A system for monitoring the integrity of a fibre optic telecommunications network comprising:
at least one junction box according to claim 1; and
a platform for monitoring interventions in said network adapted to communicate with said at least one junction box.

7. The system according to claim 6, wherein said platform comprises means for recording said interventions.
